(19) United States
(12) Patent Application Publication
(10) Pub. No.: US 2026/0194673 A1
(43) Pub. Date: Jul. 9, 2026

(54) METHOD, DEVICE, APPARATUS AND STORAGE MEDIUM FOR MIGRATION IMAGING OF SCATTERED WAVES

(71) Applicants: CHINA PETROLEUM & CHEMICAL CORPORATION, Beijing (CN); SINOPEC GEOPHYSICAL RESEARCH INSTITUTE CO., LTD., Nanjing (CN)

(72) Inventors: Kun XIANG, Nanjing (CN); Yingzhe BAI, Nanjing (CN); Jiexiong CAI, Nanjing (CN); Xinbiao DUAN, Nanjing (CN)

(21) Appl. No.: 19/131,931

(22) PCT Filed: Nov. 22, 2023
(86) PCT No.: PCT/CN2023/133140

§ 371 Date: May 21, 2025

(30) Foreign Application Priority Data
Nov. 22, 2022 (CN) 202211467817.0

(51) Int. Cl. G01V 1/30; G01V 1/36

(52) U.S. Cl. CPC G01V 1/301; G01V 1/303; G01V 1/364; G01V 2210/51; G01V 2210/6222

(57) ABSTRACT

The present disclosure belongs to the technical field of seismic exploration, and specifically relates to a method, device, apparatus and storage medium for migration imaging of scattered waves. A method for the migration imaging of scattered waves includes: acquiring a scattered wave data volume and one or more velocity models; performing a coherent migration operation on the scattered wave data volume to generate a coherent migration operator corresponding to the scattered wave data volume; generating one or more respective integral paths based on the one or more velocity models; associating the coherent migration operator with the one or more integral paths respectively to determine one or more respective coherent migration results; and superimposing the one or more respective coherent migration results to obtain a migration imaging result.

### CROSS-REFERENCE TO RELATED APPLICATIONS

This application claims the priority of Chinese patent application 202211467817.0, filed on Nov. 22, 2022, entitled “A method, device, apparatus and storage medium for migration imaging of scattered waves”, the entire contents of which are incorporated into this application by reference.

### TECHNICAL FIELD

The present disclosure belongs to the technical field of seismic exploration, and specifically relates to a method, device, apparatus, storage medium, computer program product and cloud computing system for migration imaging of scattered waves.

### BACKGROUND

In seismic exploration, from a physical point of view, if there are abnormal geological bodies underground or the underground wave impedance interface is uneven, seismic waves will scatter when the scale of the concave (or convex) part is small or comparable to the wavelength thereof, forming seismic scattered waves. After the seismic waves incident on the abnormal area (or obstacle) of the medium are scattered, they propagate irregularly in all directions from the abnormal geological bodies. Therefore, the detection of the abnormal geological bodies can be achieved by imaging the scattered wave data volume.

Conventional imaging methods mainly image seismic reflection waves. Since scattered waves have no regularity in their propagation process, traditional migration methods, such as Kirchhoff migration, wave equation migration, ray migration etc., cannot completely migration image the scattered wave data volume. Therefore, after imaging, the recognition accuracy of the abnormal geological bodies is not high.

For example, a Chinese patent application with patent publication number CN115701551A discloses a three-dimensional Kirchhoff integral pre-superimposition time migration fast imaging method, which is characterized in that the three-dimensional Kirchhoff integral pre-superimposition time migration fast imaging method comprises: step 1, collecting velocity models and seismic data for migration imaging; step 2, completing the calculation of travel time of scattering points in different layers on different threads; step 3, based on the instruction set, parallelly realizing the calculation of the travel time of 4 longitudinal sampling points in each channel, and storing it in the SSE register; step 4, for each scattering point, performing geometric diffusion compensation of amplitude energy, completing scanning and superimposing of diffraction energy, and realizing migration imaging processing based on scattering points; step 5, performing migration imaging within the migration aperture range, and completing multi-threaded fast imaging processing under a single machine.

The Chinese patent application with the patent publication number CN114910952A discloses a scattered wave imaging method and device, wherein the method comprises: calculating the kernel function of the angle channel set generated by seismic data; calculating the generalized Fourier slice theorem interpolation operator of the angle channel set, according to the kernel function of the angle channel set; the generalized Fourier slice theorem interpolation operator is an array, and the parameters of the array include the illumination inclination angle of the angle channel set and the wave number corresponding to the depth in the angle channel set; performing L1 norm and L2 norm sparse inversion on the angle channel set, according to the generalized Fourier slice theorem interpolation operator of the angle channel set, to obtain a three-dimensional model representing the two-dimensional array of the angle channel set; obtaining the scattered wave imaging result, according to the three-dimensional model representing the two-dimensional array of the angle channel set. The Chinese patent application obtains the scattered wave imaging result according to the kernel function of the angle channel set.

The Chinese patent application with the patent publication number CN115220104A discloses an anisotropic seismic migration imaging method, device, electronic device and medium. The method may include: establishing an observation system, reading the velocity model and migration parameters; using variable space step grid division according to the velocity model and migration parameters, calculating the forward simulation differential coefficient; according to the anisotropic wave equation, based on the grid distribution information and the forward simulation differential coefficient, calculating the source wave field and the detection point wave field of each shot at each time; performing cross-correlation operation on the source wave field and the detection point wave field at the same time of the shot, to obtain the single shot migration result; superimposing all the single shot migration results and outputting the final migration result. The Chinese patent application involves anisotropic migration imaging to obtain high-precision seismic wave fields.

The above existing technologies have not been able to solve the technical problem of the accuracy of identifying small-scale geological anomalies in carbonate reservoirs. In addition, in order to effectively identify small-scale anomalies on seismic imaging sections, the reflection wave field and the diffraction wave field can also be separated based on the difference in the kinematic characteristics of the reflection wave and the scattered wave, and then the diffraction wave field can be imaged to achieve enhanced target imaging of the diffracted body. Regardless of whether the scattered wave separation is performed, the scattered wave imaging method is greatly affected by the migration velocity model; when the geological structure is complex, since a better migration velocity model cannot be obtained, this will restrict the effect of the scattered wave imaging.

Therefore, there is a need in the art for continuous improvement in the migration imaging technique of scattered waves.

### SUMMARY

In response to the above technical problems, the present disclosure proposes a scattered wave migration imaging method, device, apparatus, storage medium, computer program product and cloud computing system. The present disclosure introduces the coherence principle in optical imaging, combines it with the migration imaging process, and proposes a coherent migration imaging operation or operator; and integrates the path integral method in mathematical theory into the scattered wave imaging process, and combines it with the coherent migration operator to propose a coherent path integral scattered wave imaging technology. The present disclosure no longer relies on an accurate velocity model, and overcomes the imaging blur phenomenon caused by inaccurate velocity. The method proposed in the present disclosure does not require an accurate velocity model, and obtains scattered wave imaging results based on the scattered wave data volume, which can solve the ambiguity of scattered wave imaging results caused by inaccurate velocity.

In a first aspect, the present disclosure provides a method for migration imaging of scattered waves, which includes: acquiring a scattered wave data volume and one or more velocity models; performing a coherent migration operation on the scattered wave data volume to generate a coherent migration operator corresponding to the scattered wave data volume; generating one or more respective integral paths based on the one or more velocity models; associating the coherent migration operator with the one or more integral paths, respectively, to determine one or more respective coherent migration results; and superimposing the one or more respective coherent migration results to obtain a migration imaging result.

In some embodiments, the scattered wave migration imaging method further includes: before performing the coherent migration operation on the scattered wave data volume, filtering the scattered wave data volume. For example, in one example, a filtering range of the scattered wave data volume may be determined, and before performing the migration imaging, the scattered wave data volume may be filtered according to the filtering range.

In some embodiments, the scattered wave migration imaging method further includes: before performing the coherent migration operation on the scattered wave data volume, performing a thresholding processing on the scattered wave data volume. For example, the thresholding processing includes: when the amplitude of data of the scattered wave data volume is less than a threshold value, not performing the coherent migration operation on the data of the scattered wave data volume, thereby reducing the computational load. In addition, the above filtering processing and thresholding processing can remove the influence of seismic noise, so that the final imaging result has good stability.

In some embodiments, performing a coherent migration operation on the scattered wave data volume includes: performing a coherent migration operation on the scattered wave data volume according to partial information contained in the scattered wave data volume. For example, the partial information may be time information or depth information corresponding to the time information.

In some embodiments, performing a coherent migration operation on the scattered wave data volume includes: determining a scan length for each data in at least a portion of data in the scattered wave data volume according to a sampling time of each data, the scan length being used to limit a range of adjacent data required to perform the coherent migration operation; and generating the coherent migration operator using adjacent data whose distances to each data are within the scan length.

In some embodiments, for data, U_{f}(x,y,t), in the scattered wave data volume, the coherent migration operator is generated according to the scan length by the following formula:

$$ρ ( x , y , t ) = {[ {\sum }_{i = 0}^{R ( t )} {U}_{f} ( x \pm i * dx , y \pm i * dy , t \pm i * d t ) ]}^{2} \text{} / {\sum }_{i = 0}^{R ( t )} {U}_{f}^{2} ( x \pm i * dx , y \pm i * dy , t \pm i * d t )$$

wherein, U represents the amplitude of the scattered wave, f represents the frequency of the scattered wave, x represents the X-direction coordinate of the scattered wave and is between a first minimum value xₘᵢₙ and a first maximum value xₘₐₓ, y represents the Y-direction coordinate of the scattered wave and is between a second minimum value yₘᵢₙ and a second maximum value yₘₐₓ, dx represents the X-direction step of the scattered wave, dy represents the Y-direction step of the scattered wave, t represents the sampling time of the scattered wave and is between zero and a maximum sampling time tₘₐₓ, dt represents the sampling time step in the longitudinal direction T; ρ represents the coherent migration operator; R(t) represents the scanning length and is a function of the sampling time t, i=0, . . . , R(t), and R(t) is a positive integer;

$${\sum }_{i = 0}^{R ( t )}$$

represents the sum of each item from i=0 to R(t); and x, y and t are changed respectively, and the above generation steps for the coherent migration operator are repeated until coherent migration operators of part or all of data in the scattered wave data volume are respectively determined. In one example, through the above conversion, each data of the scattered wave data volume can be mapped to each data of the coherent migration operator by using the adjacent data range defined by the scanning radius, through the coherent migration operation.

In some embodiments, the scan length R(t) is proportional to the sampling time t, or the scan length R(t) is a constant.

In some embodiments, acquiring one or more velocity models required for processing the scattered wave data volume includes: receiving the one or more velocity models from outside, predefining the one or more velocity models, or randomly generating the one or more velocity models.

In some embodiments, the number n of the one or more velocity models is determined by the following formula:

$$n = ( {v}_{b} - {v}_{a} ) / dv + 1$$

where, v_{b} represents the upper speed limit of the speed model, va represents the lower speed limit of the speed model, and dv represents the speed step, wherein the jth speed model is represented by vⱼ, j=1, . . . , n, where the value of vⱼ is equal to (j−1)*dv+vₐ. In one example, the speed upper limit, speed lower limit and step in the speed model may be assigned preset values. In addition, in one example, the speed model may be generated based on the speed upper limit, speed lower limit and step.

In some embodiments, generating one or more respective integral paths based on the one or more velocity models includes: for a jth velocity model in the one or more velocity models, generating a jth integral path by the following formula:

$${τ}_{j} ( x , y , t ) = \sqrt{{t}^{2} + ( \frac{{( 2 {r}_{j} )}^{2}}{{v}_{j}^{2} ( x , y , t )} )}$$

wherein, τⱼ represents the jth integral path, j=1, . . . , n; rⱼ represents an migration aperture, wherein the migration aperture represents a preset value required to process the jth velocity model; vⱼ is the jth velocity model, wherein the value of vⱼ is equal to (j−1)*dv+vₐ; and changing j, repeating the above integral path generation steps until all velocity models are converted into respective integral paths. In one example, through the above conversion, each data of the velocity model can be mapped to each data on the integral path.

In some embodiments, associating the coherent migration operator with the one or more integral paths to determine the respective coherent migration results includes: associating the coherent migration operator with the jth integral path to determine the jth coherent migration result by the following formula:

$${S}_{j} ( x , y , t ) = {\int }_{0}^{{t}_{max}} \{ {δ ( t - {τ}_{j} ( x , y , t ) ) [ {\sum }_{i = 0}^{R ( t )} {U}_{f} ( x \pm i * dx , y \pm i * dy , t \pm i * d t ) ]}^{2} \text{} / {\sum }_{i = 0}^{R ( t )} {U}_{f}^{2} ( x \pm i * dx , y \pm i * dy , t \pm i * d t ) \} d t$$

wherein, Sⱼ represents the jth coherent migration result; ∫ represents the integral sign, representing the summation of the terms in curly brackets at different times; tₘₐₓ represents the maximum sampling time; δ represents the Dirac function; dt represents the sampling time step; and by changing j, the above association steps are repeated until all integral paths are associated with the coherent migration operator to determine the respective coherent migration results.

In some embodiments, the superposition of the respective coherent migration results to obtain the migration imaging result is performed by the following formula:

$$D ( x , y , t ) = {\sum }_{j = 1}^{n} {S}_{j} ( x , y , t )$$

wherein, D(x,y,t) represents the migration imaging result, indicating the probability of the existence of a scatterer at the position coordinate (x,y) at the sampling time t; Σ represents the summation sign.

In addition, in some embodiments, the scattered wave data volume may be, for example, collected in a seismic exploration situation or stored in a data storage device. For example, in one example, the scattered wave data volume may include a plurality of time slice data, each of which may include, for example, the scattered wave amplitude at different coordinate positions in a horizontal cross section (e.g., defined by an X-axis and a Y-axis). In this example, the time information in the scattered wave data volume may also reflect or represent the depth information at which the scattering phenomenon occurs. In some embodiments, a coherent migration operation may also be performed on the scattered wave data volume according to the time information or the depth information contained in the data volume. For example, in one example, a scan length is determined based on the time information or the depth information contained in the data volume, thereby determining a coherent migration operator for the scattered wave data volume, as described above.

In a second aspect, the present disclosure proposes a device for migration imaging of scattered wave, which includes: an acquisition module, configured to acquire a scattered wave data volume and one or more velocity models; an execution module, configured to perform a coherent migration operation on the scattered wave data volume to generate a coherent migration operator corresponding to the scattered wave data volume; a generation module, configured to generate one or more respective integral paths based on the one or more velocity models; an association module, configured to associate the coherent migration operator with the one or more integral paths respectively to determine a respective coherent migration result; and a superposition module, configured to superimpose the respective coherent migration results to obtain the migration imaging result.

In a third aspect, the present disclosure provides an electronic device comprising a storage device and a processor, wherein the storage device stores a computer program, and when the processor executes the computer program, the method for migration imaging of scattered waves described in any one of the first aspects is implemented.

In a fourth aspect, the present disclosure provides a storage medium, wherein a computer program stored in the storage medium can be executed by at least one processor, and the computer program can be used to implement the method for migration imaging of scattered waves described in any one of the first aspects.
a fifth aspect, the present disclosure provides a computer program product, which includes a computer program executable by at least one processor. The computer program can be used to implement the scattered wave migration imaging method described in any one of the first aspects.
a sixth aspect, the present disclosure provides a cloud computing system, comprising: one or more processors, the one or more processors being connected to each other via a network; and a memory unit coupled to the one or more processors, wherein the memory unit stores a computer program in the form of machine-readable instructions executable by the one or more processors, wherein the machine-readable instructions cause the one or more processors to perform the scattered wave migration imaging method described in any one of the first aspects.

The beneficial effects of the present disclosure include, for example: the coherent migration imaging operation or operator of the present disclosure makes the information of the scattered wave data more concentrated or focused; the path integration method is integrated into the scattered wave imaging process and combined with the coherent migration operation or operator, so that the coherent path integration scattered wave imaging technology of the present disclosure can solve the fuzzy results of the scattered wave imaging caused by inaccurate velocity, improving the accuracy of fracture-cavity imaging, and thus improving the prediction accuracy of carbonate fracture-cavity reservoirs; and the coherent path integration scattered wave imaging technology can fully calculate the information contained in the scattered wave data volume, and the imaging quality is high, not easily affected by seismic noise, and has good stability.

### BRIEF DESCRIPTION OF THE DRAWINGS

The present disclosure may be better understood by reading the following detailed description of exemplary embodiments in conjunction with the accompanying drawings, wherein:

FIG. 1 is a schematic diagram of the formation mechanism and propagation mode of scattered waves.

FIG. 2 is a flow chart of a method for migration imaging of scattered waves according to an embodiment of the present disclosure;

FIG. 3A is a schematic diagram of one example of a scattered wave data volume and a scan length according to an embodiment of the present disclosure;

FIG. 3B is a schematic diagram of another example of a scattered wave data volume and a scan length according to an embodiment of the present disclosure;

FIG. 4 is a schematic diagram of one example of one of velocity models according to an embodiment of the present disclosure;

FIG. 5 is a structural block diagram of a scattered wave migration imaging device according to an embodiment of the present disclosure;

FIG. 6 is a structural block diagram of an electronic device according to an embodiment of the present disclosure;

FIGS. 7a-8c are schematic diagrams comparing imaging results of the conventional PSDM technology with imaging results of the migration imaging method of the present disclosure, according to an application example of an embodiment of the present disclosure;

FIGS. 9 and 10 are schematic diagrams comparing imaging results of the conventional RTM technology with imaging results of the migration imaging method of the present disclosure, according to another application example of an embodiment of the present disclosure; and

FIGS. 11 and 12 are schematic diagrams comparing imaging results of the conventional RTM technology with imaging results of the migration imaging method of the present disclosure, according to still another application example of an embodiment of the present disclosure.

### DETAILED DESCRIPTION

In order to make the objectives, technical solutions and advantages of the present disclosure clearer, the present disclosure will be further described in detail below in conjunction with the accompanying drawings. The described embodiments should not be regarded as limiting the present disclosure. All other embodiments obtained by ordinary skilled in the art without making creative work are within the scope of protection of the present disclosure.

In the following description, reference is made to “some embodiments” which describe a subset of all possible embodiments, but it is understood that “some embodiments” may be the same subset or different subsets of all possible embodiments and may be combined with each other without conflict.

If “first\second\third” appear in the public document, then the following explanation is added. In the following description, the terms “first\second\third” involved are only used to distinguish similar objects and do not represent a specific ordering of the objects. It can be understood that “first\second third” can be interchanged in a specific order or sequence where permitted, so that the embodiments of the present disclosure described herein can be implemented in an order other than that illustrated or described herein.

Unless otherwise defined, all technical and scientific terms used herein have the same meaning as those commonly understood by those skilled in the art to which the present disclosure belongs. The terms used herein are only for the purpose of describing the embodiments of the present disclosure and are not intended to limit the present disclosure.

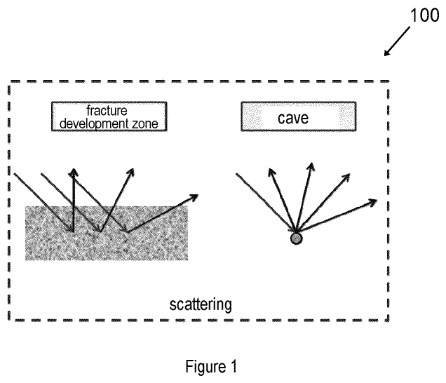

FIG. 1 is a schematic diagram of the formation mechanism and propagation mode of scattered waves. The development of small-scale inhomogeneous bodies (caves) and cracks manifests itself in very complex wave field characteristics in seismic response. For example, small cracks and small caves in carbonate rock development areas, whose scale is less than or equal to the wavelength of seismic waves, are the main scattering sources underground. When seismic waves propagate to such scattering sources, they do not follow the law of reflection, but scatter in all directions, as shown in FIG. 1.

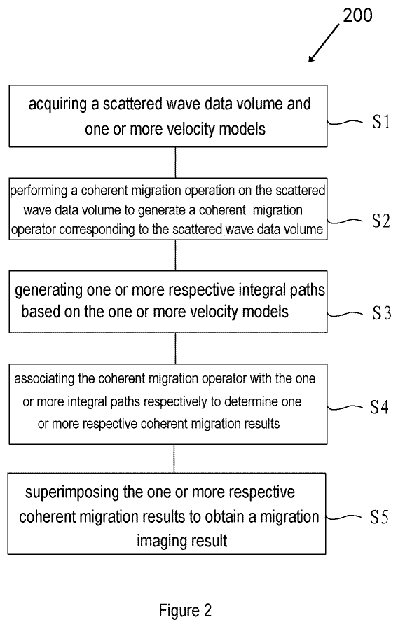

As shown in FIG. 2, the present disclosure provides a method for migration imaging of scattered waves, which can be implemented by any type of electronic devices, such as a server, a mobile terminal, a computer, a cloud platform or a computing system and so on. The functions implemented by the data processing according to the embodiment of the present disclosure can be implemented by calling a program code by a processor of the electronic device, and the program code can be stored in a computer storage medium or any other type of computer program product. The method for migration imaging of scattered waves includes steps S1 to S5.

Step S1, acquiring a scattered wave data volume and one or more velocity models.

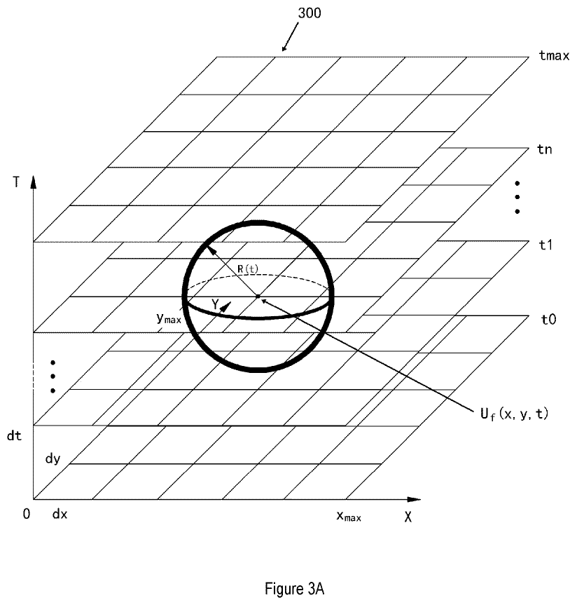

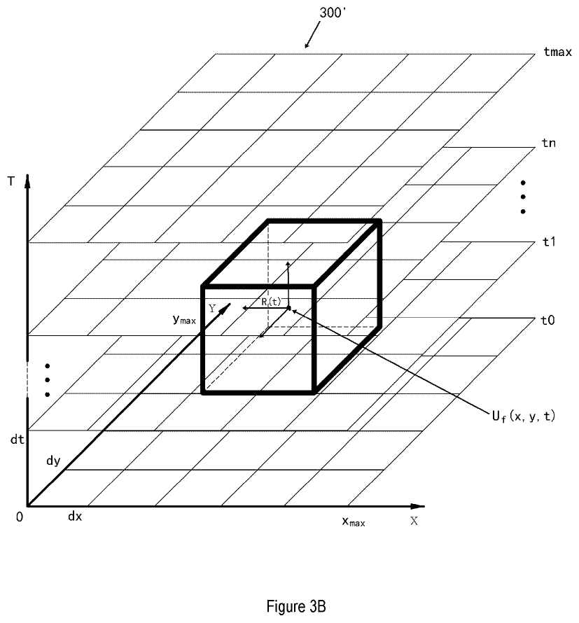

As used herein, a “scattered wave data volume” may, for example, refer to multi-dimensional scattered wave data, such as two-dimensional, three-dimensional or higher-dimensional scattered wave data, such as but not limited to seismic scattered wave data collected in seismic exploration or any other type of scattered wave data. In the following, for the sake of simplicity, a “scattered wave data volume” may, for example, refer to a three-dimensional scattered wave data volume, including scattered wave data at different positions (x,y) in a horizontal plane collected at different sampling times t (e.g., in the longitudinal direction T), or in other words, including different time slice data, wherein the expression U(x,y,t) or U_{f}(x,y,t) may represent scattered wave data at specific coordinates (x,y,t), so that the scattered wave data at different x, different y and different t constitute a three-dimensional scattered wave data volume, wherein U represents the amplitude of the scattered wave (e.g., ranging from 10⁻⁸ to 10¹⁴, from 10⁻⁷ to 10¹³, from 10⁻⁶ to 10¹², from 10⁻⁵ to 10¹¹, from 10⁻⁴ to 10¹⁰, from 10⁻³ to 10⁹, from 10⁻² to 10⁸, or from 10⁻¹ to 10⁷, etc.), f represents the frequency of the scattered wave (for example, ranging from 1 Hz to 5000 Hz, from 4 Hz to 1 000 Hz, from 10 Hz to 800 Hz, from 50 Hz to 400 Hz, from 100 Hz to 400 Hz, from 200 Hz to 400 Hz, etc.), x represents the X-direction coordinate of the scattered wave and is between a first minimum value xₘᵢₙ (for example, ranging from 0 to −20 km) and a first maximum value xₘₐₓ (for example, ranging from 0 to 20 km), y represents the Y-direction coordinate of the scattered wave and is between a second minimum value yₘᵢₙ (for example, ranging from 0 to −20 km) and a second maximum value yₘₐₓ (for example, ranging from 0 to 20 km); t represents the sampling time of the scattered wave and is between zero and a maximum sampling time tₘₐₓ (for example, 1 s, 3 s, 6 s, 10 s, 20 s, 100 s, etc.), see FIG. 3A or FIG. 3B for details.

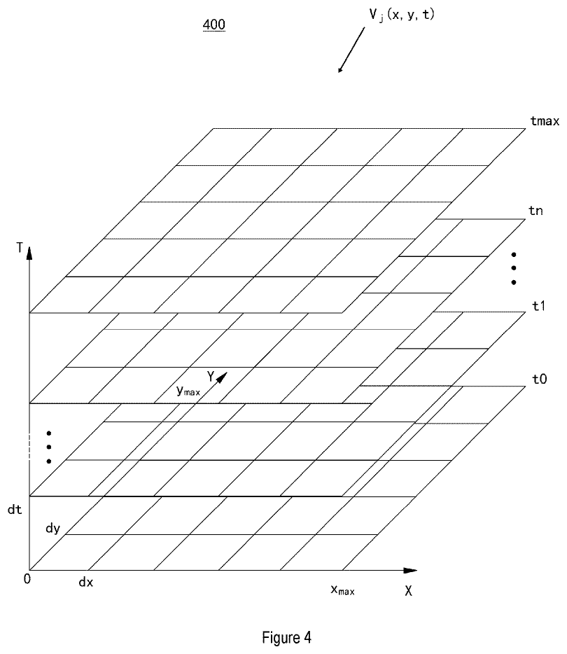

As used herein, a “velocity model” may, for example, refer to multi-dimensional velocity data, such as two-dimensional, three-dimensional or higher dimensional velocity data, for processing a scattered wave data volume. In the following, for the sake of simplicity of description, a “velocity model” may, for example, refer to a three-dimensional velocity data volume, including velocity data at different positions (x,y) in a horizontal plane at different times t, or in other words, including different time slice velocity data, which is for example represented by an expression v(x,y,t). For example, in the case of multiple velocity models, vⱼ (x,y,t) may represent the jth velocity model, as shown in, for example, FIG. 4. In one example, the number n of velocity models may be determined, for example, by the following formula:

$$n = ( {v}_{b} {v}_{a} ) / dv + 1$$

wherein, v_{b} represents the upper speed limit of the speed model (e.g., 10⁴ m/s, 10⁵ m/s, 10⁶ m/s, etc.), vₐ represents the lower speed limit of the speed model (e.g., 1000 m/s, 500 m/s, 100 m/s, 50 m/s, etc.), and dv represents the speed step (e.g., ranging from 10 to 100 m/s, etc.). In one example, vⱼ (x,y,t) value is equal to (j−1)*dv+vₐ. Of course, other variable step implementations can also be adopted to obtain different divisions of the speed model. Due to the technology in the present disclosure, the constraints or accuracy requirements on the speed model are relaxed.

During seismic exploration, abnormal geological bodies or the wave impedance interface underground will cause scattering phenomenon, and thereafter, a scattered wave data volume will be generated. In order to better restore the actual situation underground, it is necessary to perform migration imaging operations on the scattered wave data volume. Since the recognition accuracy of the migration imaging results in the related art is not high, various technical means are proposed in the present disclosure to improve the accuracy of the migration imaging results, as further described below.

In order to improve the quality of the migration imaging, it is also necessary to filter the scattered wave data volume. Therefore, in some embodiments, the scattered wave migration imaging method also includes: determining the filtering range of the scattered wave data volume; and filtering the scattered wave data volume according to the filtering range before performing the migration imaging.

Before performing the coherent migration operation on the scattered wave data volume, in order to ensure the accuracy of the data, the scattered wave data volume needs to be filtered. Before filtering, the filtering range must be determined firstly, and then the scattered wave data volume is filtered according to the filtering range.

In some embodiments, the scattered wave data may be filtered by the following expression:

$${U}_{f} ( x , y , t ) = {\int }_{{f}_{1}}^{{f}_{2}} U ( x , y , t ) df / f ,$$

wherein, f₁, f₂ respectively represent the lower and upper frequency limits in the filter range, which can be set as needed; U(x,y,t) represents the original scattered wave data, U_{f}(x,y,t) represents the filtered scattered wave data. When x, y and t are changed, U(x,y,t) or U_{f}(x,y,t) under different x, y and t constitutes the original or filtered three-dimensional scattered wave data or data volume.

In addition, in some embodiments, before performing the coherent migration operation on the scattered wave data volume, a thresholding processing may be performed on the scattered wave data volume. For example, the thresholding processing includes not performing the coherent migration operation on the data of the scattered wave data volume when the amplitude of the data of the scattered wave data volume is less than a specific threshold, thereby reducing the subsequent calculation load.

Step S2: performing a coherent migration operation on the scattered wave data volume to generate a coherent migration operator corresponding to the scattered wave data volume.

The coherent migration operator is an important parameter when performing migration imaging on the scattered wave data volume. In order to improve the quality of the final migration imaging, it is necessary to perform a coherent migration operation on the scattered wave data volume. In one embodiment, the coherent migration operator can be determined according to the time information or depth information contained in the scattered wave data volume. For example, in one example, the scattered wave data volume can include a plurality of time slice data, and each time slice data can include, for example, the amplitude of the scattered wave at different coordinate positions in a horizontal cross section (for example, defined by the X-axis and the Y-axis). In this example, the time information in the scattered wave data volume can also reflect or represent the depth information that the scattering phenomenon occurs, because the depth information can be associated with the sampling time according to the propagation speed of the scattered wave. In some embodiments, the coherent migration operation can also be performed on the scattered wave data volume according to the time information or depth information contained in the data volume. For example, in one example, the scanning length is determined according to the time information or depth information contained in the data volume, thereby determining the coherent migration operator of the scattered wave data volume.

In some embodiments, step S2 “performing a coherent migration operation on the scattered wave data volume” further includes: for each data in at least part or all of the data in the scattered wave data volume, determining a scan length according to the sampling time of each data, the scan length being used to limit the range of adjacent data required to perform the coherent migration operation; and using adjacent data whose distances to each data are within the scan length to generate the coherent migration operator, see FIGS. 3A and 3B for details.

In the present disclosure, the scan length is an important data for determining the coherent migration operator. In one example, the scan length may be related to the sampling time of each data or the depth information contained therein, and therefore, the scan length of the data may be determined according to the sampling time or depth information of each data, and then the coherent migration operator may be determined according to the scan length.

In some embodiments, the step of “generating the coherent migration operator according to the scan length” may be performed by the following formula:

$$ρ ( x , y , t ) = {[ {\sum }_{i = 0}^{R ( t )} {U}_{f} ( x \pm i * dx , y \pm i * dy , t \pm i * d t ) ]}^{2} \text{} / {\sum }_{i = 0}^{R ( t )} {U}_{f}^{2} ( x \pm i * dx , y \pm i * dy , t \pm i * d t )$$

Wherein, ρ represents the coherent migration operator; R(t) represents the scan length and is a function of the sampling time t, i=0, . . . , R(t), and R(t) takes a positive integer (for example, ranging from 1 to 100, from 1 to 50, from 1 to 40, from 1 to 30 or from 1 to 20, etc.);

$${\sum }_{i = 0}^{R ( t )}$$

represents the summation of each term from i=0 to R(t). As described above, U_{f}(x,y,t) represents scattered wave data at the data volume coordinates (x,y,t) or at the position coordinates (x,y) at the time slice t, wherein U represents the amplitude of the scattered wave, f represents the frequency of the scattered wave, x represents the X-direction coordinate of the scattered wave and is between a first minimum value xₘᵢₙ and a first maximum value xₘₐₓ, y represents the Y-direction coordinate of the scattered wave and is between a second minimum value yₘᵢₙ and a second maximum value yₘₐₓ, dx represents the X-direction step of the scattered wave (for example, 1 m, 5 m, 10 m, 20 m, 50 m, 100 m, etc.), dy represents the Y-direction step of the scattered wave (for example, 1 m, 5 m, 10 m, 20 m, 50 m, 100 m, etc.), t represents the sampling time of the scattered wave and is between zero and the maximum sampling time tₘₐₓ, dt represents the sampling time step (for example, 0.1 ms, 1 ms, 3 ms, 6 ms, 10 ms, 20 ms, 100 ms, etc.) in the longitudinal direction T, and the numerical ranges of other parameters can be, for example, referred to the above description.

FIG. 3A is a schematic diagram of one example of a scattered wave data volume 300 and a scan length R(t) according to an embodiment of the present disclosure. As shown in FIG. 3A, the center of the bold sphere represents the scattered wave volume U_{f}(x,y,t) at the specific coordinate position (x,y,t), and the scan length R(t) is represented by the radius of the bold sphere, as shown by the arrow. In order to perform a coherent migration operation on U_{f}(x,y,t) at the specific position, the data within the range of the bold sphere defined by the scan length R(t) can be selected, for example, to perform the coherent migration operation through the above formula, thereby generating the coherent migration operator ρ(x,y,t) corresponding to U_{f}(x,y,t) at the specific position. In addition, the coordinate positions are changed or the values of x, y and t are changed respectively, and the above coherent migration operator generation step is repeated, so that coherent migration operators of part or all of the data in the scattered wave data volume can be determined.

FIG. 3B is a schematic diagram of one example of a scattered wave data volume 300′ and a scan length R(t) according to an embodiment of the present disclosure. As shown in FIG. 3B, the center of the thick-line cube represents the scattered wave data volume U_{f}(x,y,t) at the specific coordinate position (x,y,t), and the scan length R(t) is represented by an arrow. In order to perform a coherent migration operation on U_{f}(x,y,t) at the specific position, for example, adjacent data within the range of the cube defined by the scan length R(t) can be selected, to perform the coherent migration operation through the above formula, thereby generating the coherent migration operator ρ(x,y,t). In addition, the coordinate positions or the values of x, y and t are changed respectively, and the above coherent migration operator generation step is repeated, so that coherent migration operators of part or all of the data in the scattered wave data volume can be determined.

FIG. 3A and FIG. 3B of the present application show examples of the scan length R(t) and its corresponding sphere and cube, the shape of the scan length R(t) and its defined data volume may include, but is not limited to, a cuboid, a cone, and any other similar shape. In addition, the scan length R(t) may vary or be constant with time t, or may also vary or be constant with position coordinates (x,y). In one example, the scan length R(t) is proportional to the sampling time t, or the scan length R(t) is a constant.

In addition, although the coherent migration operation formula uses a quadratic expression, the inventors have invented that cubic or higher-order expressions can also be considered and weighting coefficients can be introduced according to the distance from adjacent data to the data to be converted, so that the coherent migration operation can achieve better data focusing effects.

Step S3: generating one or more respective integral paths based on the one or more velocity models.

As described above, a “velocity model” may, for example, refer to a three-dimensional velocity data volume, including velocity data at different positions (x,y) in a horizontal plane at different times t, or in other words, including different time slice velocity data, wherein an expression v (x,y,t) may represent the velocity at a specific coordinate (x,y,t), such that the velocities at different x, different y, and different t constitute a three-dimensional velocity data volume. In some embodiments, the one or more velocity models may be received from the outside, predefined, or randomly generated. As described above, due to the related migration operation of the present disclosure, the constraints on the velocity model are reduced.

FIG. 4 is a schematic diagram of one example of one of the velocity models 400 according to an embodiment of the present disclosure. As shown in FIG. 4, the respective coordinate axis parameters are similar to those in FIG. 3A and FIG. 3B, wherein x represents the X-direction coordinate and is between the first minimum value xₘᵢₙ and the first maximum value xₘₐₓ, y represents the Y-direction coordinate and is between the second minimum value yₘᵢₙ and the second maximum value yₘₐₓ, dx represents the X-direction step (e.g., 1 m, 5 m, 10 m, 20 m, 50 m, 100 m, etc.), dy represents the Y-direction step (e.g., 1 m, 5 m, 10 m, 20 m, 50 m, 100 m, etc.), t represents the sampling time and is between zero and the maximum sampling time tₘₐₓ, dt represents the sampling time step (e.g., 0.1 ms, 1 ms, 3 ms, 6 ms, 10 ms, 20 ms, 100 ms, etc.) in the longitudinal direction T, and the numerical ranges of other parameters can be, for example, referred to the above description.

In one embodiment, for example, in the case of multiple velocity models, vⱼ (x,y,t) represents the velocity data of the jth velocity model at the coordinate (x,y,t), as shown in FIG. 4. When x, y and t are changed, the velocities at different x, different y and different t vⱼ (x,y,t) constitute a three-dimensional velocity data volume or simply referred to as the jth velocity model. In this application, depending on the context, sometimes the vⱼ(x,y,t) may also refer to the jth velocity model, which also applies to the case of the scattered wave data volume.

In one example, the number n of velocity models may be determined, for example, by the following formula:

$$n = ( {v}_{b} - {v}_{a} ) / dv + 1$$

wherein, v_{b} represents the upper speed limit (e.g., 10⁴ m/s, 10⁵ m/s, 10⁶ m/s, etc.), vₐ represents the lower speed limit (e.g., 1000 m/s, 500 m/s, 100 m/s, 50 m/s, etc.), and dv represents the speed step (e.g., ranging from 10 to 100 m/s, etc.). In this case, the upper and lower limits of each speed model are different. For example, the speed of the jth speed model is equal to (j−1)*dv+vₐ. For the jth speed model, a speed data set equal to (j−1)*dv+vₐ at different x, different y, and different t can be predefined or received, thereby forming a three-dimensional jth speed data volume or speed model.

Next, in one example, for the jth velocity model among the one or more velocity models, the jth integral path may be generated, for example, by the following formula:

$${τ}_{j} ( x , y , t ) = \sqrt{{t}^{2} + ( \frac{{( 2 {r}_{j} )}^{2}}{{v}_{j}^{2} ( x , y , t )} )}$$

wherein, τⱼ represents the jth integral path, j=1, . . . , n; rⱼ represents the migration aperture, which represents the preset value required to process the jth velocity model (for example, ranging from 10¹ to 10⁵ m, from 10² to 10⁴ m, etc.); vⱼ represents the jth velocity model, where vⱼ value is equal to (j−1)*dv+vₐ.

From the above integral path formula, it can be seen that each data of the jth velocity model can be mapped to each data on the jth integral path, and the two are in a one-to-one correspondence. In addition, the integral path formula can also introduce a weighting coefficient to the summation term, so that the operation can achieve better data processing effects.

Then, for each velocity model, similar integral path generation steps are performed until all velocity models are converted into respective integral paths, thus obtaining n integral paths.

Step S4: associating the coherent migration operator with the one or more integral paths respectively to determine one or more respective coherent migration results.

In some embodiments, the coherent migration operator obtained above ρ(x,y,t) may be associated with the jth integration path τⱼ(x,y,t) to determine the jth coherent migration result, for example, by the following formula:

$${S}_{j} ( x , y , t ) = {\int }_{0}^{{t}_{max}} \{ {δ ( t - {τ}_{j} ( x , y , t ) ) [ {\sum }_{i = 0}^{R ( t )} {U}_{f} ( x \pm i * dx , y \pm i * dy , t \pm i * d t ) ]}^{2} / {\sum }_{i = 0}^{R ( t )} {U}_{f}^{2} ( x \pm i * dx , y \pm i * dy , t \pm i * d t ) \} d t$$

wherein, Sⱼ represents the jth coherent migration result; ∫ represents the integral sign, representing the sum of the terms in curly brackets at different times; tₘₐₓ represents the maximum sampling time; δ represents the Dirac function; dt represents the sampling time step, and the various parameters in the formula can be, for example, referred to the above description. Although the above association formula uses the Dirac function, it can also use the Gaussian function, Laplace function, etc.

Then, for each of the n integration paths, similar association steps are performed until all the integration paths are associated with the coherent migration operator to determine the respective coherent migration results.

Step S5: superimposing the one or more respective coherent migration results to obtain a migration imaging result or an overall migration imaging result.

In the present disclosure, after obtaining respective coherent migration results from one or more integral paths, the respective coherent migration results obtained on one or more paths may be superimposed to obtain a final migration imaging result.

In some embodiments, the step of “superimposing the one or more respective coherent migration results to obtain a migration imaging result” is performed by the following formula:

$$D ( x , y , t ) = {\sum }_{j = 1}^{n} {S}_{j} ( x , y , t )$$

wherein, D(x,y,t) represents the migration imaging result, indicating the probability of the existence of a scatterer at the position coordinate (x,y) at the sampling time t; Σ represents the summation sign.

The coherent migration imaging operation or operator in the present disclosure makes the information of the scattered wave data more concentrated or focused, and the path integration method is integrated into the scattered wave imaging process and combined with the coherent migration operation or operator, so that the scattered wave imaging technology of the coherent path integration in the present disclosure can solve the fuzzy results of the scattered wave imaging caused by inaccurate velocity. In addition, the method in the present disclosure can fully calculate the information contained in the scattered wave data volume, and the imaging quality is high, it is not easily affected by seismic noise, and has good stability. Through the method in the present disclosure, compared with the migration imaging results obtained by the related technology, the migration imaging results finally obtained have better recognition and better quality.

Based on the above-mentioned embodiments, the embodiments of the present disclosure also provide a device for the migration imaging of scattered waves, and the modules included in the device and the units included in the modules can be implemented by a processor in a computer device; of course, they can also be implemented by a logic circuit. In the implementation process, the processor can be a central processing unit (CPU), a microprocessor (MPU), a digital signal processor (DSP), or a field programmable gate array (FPGA), and the like.

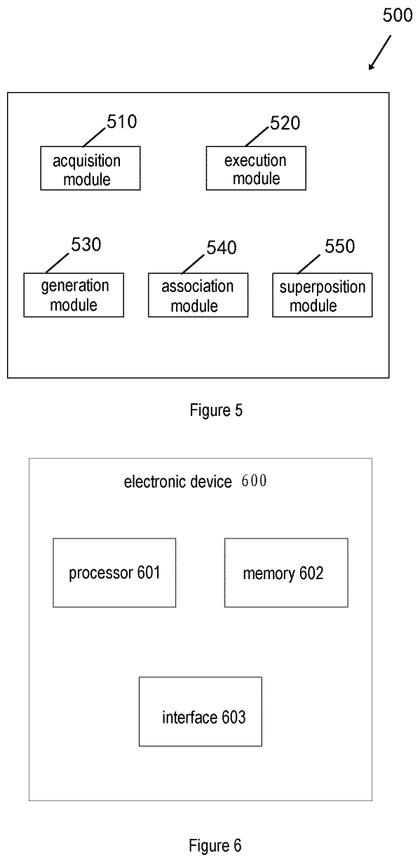

As shown in FIG. 5, the scattered wave migration imaging device may include, for example, an acquisition module 510, an execution module 520, a generation module 530 and an association module 540.

The acquisition module 510 is configured to acquire a scattered wave data volume and one or more velocity models. The execution module 520 is configured to perform a coherent migration operation on the scattered wave data volume to generate a coherent migration operator corresponding to the scattered wave data volume. The generation module 530 is configured to generate one or more respective integral paths based on the one or more velocity models. The association module 540 is configured to associate the coherent migration operator with the one or more integral paths respectively to determine respective coherent migration results. The superposition module 550 is configured to superimpose the respective coherent migration results to obtain the final or overall migration imaging result.

In some embodiments, the execution module 520 includes: a determination submodule and a generation submodule.

The determination submodule is configured to, for each data in at least part of the data in the scattered wave data volume, determine a scan length according to a sampling time of each data, wherein the scan length is used to define a range of adjacent data required to perform the coherent migration operation. The generation submodule is configured to generate the coherent migration operator using adjacent data whose distances to each data are within the scan length.

In some embodiments, the scattered wave migration imaging device further includes a filtering module and a thresholding module.

The filtering module is configured to perform filtering processing on the scattered wave data volume before performing the coherent migration operation on the scattered wave data volume. The thresholding module is configured to perform thresholding processing on the scattered wave data volume before performing the coherent migration operation on the scattered wave data volume.

In some embodiments, the generating submodule is configured to generate the coherent migration operator according to the scan length by the following formula:

$$ρ ( x , y , t ) = {[ {\sum }_{i = 0}^{R ( t )} {U}_{f} ( x \pm i * dx , y \pm i * dy , t \pm i * d t ) ]}^{2} / {\sum }_{i = 0}^{R ( t )} {U}_{f}^{2} ( x \pm i * dx , y \pm i * dy , t \pm i * d t )$$

wherein, U represents the amplitude of the scattered wave, f represents the frequency of the scattered wave, x represents the X-direction coordinate of the scattered wave and is between a first minimum value xₘᵢₙ and a first maximum value xₘₐₓ, y represents the Y-direction coordinate of the scattered wave and is between a second minimum value yₘᵢₙ and a second maximum value yₘₐₓ, dx represents the X-direction step of the scattered wave, dy represents the Y-direction step of the scattered wave, t represents the sampling time of the scattered wave and is between zero and the maximum sampling time tₘₐₓ, dt represents the sampling time step in the longitudinal direction T; ρ represents the coherent migration operator; R(t) represents the scanning length and is a function of the sampling time t, i=0, . . . , R(t), and R(t) is a positive integer;

$${\sum }_{i = 0}^{R ( t )}$$

represents the sum of each term from i=0 to R(t); and by changing x, y and t respectively, the above coherent migration operator generation step is repeated until coherent migration operators of part or all of data in the scattered wave data volume are respectively determined, wherein the various parameters are, for example, referred to the above description.

In some embodiments, the generation module 530 may be configured to generate the jth integral path for the jth velocity model among the one or more velocity models by using the following formula:

$${τ}_{j} ( x , y , t ) = \sqrt{{t}^{2} + ( \frac{{( 2 {r}_{j} )}^{2}}{{v}_{j}^{2} ( x , y , t )} )}$$

wherein, τⱼ represents the jth integral path, j=1, . . . , n; rⱼ represents an migration aperture, wherein the migration aperture represents a preset value required to process the jth velocity model; vⱼ represents the jth velocity model, wherein vⱼ value is equal to (j−1)*dv+vₐ; and by changing j, the above integral path generation step is repeated until all velocity models are converted into respective integral paths, wherein the various parameters are, for example, referred to the description above.

In some embodiments, the association module 540 may be configured to associate the coherent migration operator with the jth integration path to determine the jth coherent migration result, by the following formula:

$${S}_{j} ( x , y , t ) = {\int }_{0}^{{t}_{max}} \{ {δ ( t - {τ}_{j} ( x , y , t ) ) [ {\sum }_{i = 0}^{R ( t )} {U}_{f} ( x \pm i * dx , y \pm i * dy , t \pm i * d t ) ]}^{2} / {\sum }_{i = 0}^{R ( t )} {U}_{f}^{2} ( x \pm i * dx , y \pm i * dy , t \pm i * d t ) \} d t$$

wherein, Sⱼ represents the jth coherent migration result; ∫ represents the integral sign, representing the summation of the terms in curly brackets at different times; tₘₐₓ represents the maximum sampling time; δ represents the Dirac function; dt represents the sampling time step; and by changing j, the above association step is repeated until all integral paths are associated with the coherent migration operator to determine the respective coherent migration results, wherein the various parameters are, for example, referred to the description above.

In some embodiments, the superposition module 550 may be configured to perform the superposition of the respective coherent migration results to obtain the overall migration imaging result by the following formula:

$$D ( x , y , t ) = {\sum }_{j = 1}^{n} {S}_{j} ( x , y , t )$$

wherein, D(x,y,t) represents the migration imaging result, indicating the probability size of the existence of a scatterer at the position coordinate (x,y) at the sampling time t; Σ represents the summation sign; wherein each parameter, for example, refers to the above description.

The above are only several examples of implementing the formulas of the present disclosure, and other forms with similar or identical functions may also be used. In addition, although the above formulas give general expressions, they are also applicable to the representation of specific positions such as (x₀, y₀) or (x₀, y₀, t₀), which will not be further described here.

The coherent migration imaging operation or operator in the present disclosure makes the information of the scattered wave data more concentrated or focused, and the path integration method is integrated into the scattered wave imaging process and combined with the coherent migration operation or operator, so that the scattered wave imaging technology of the coherent path integration in the present disclosure can solve the fuzzy results of the scattered wave imaging caused by inaccurate velocity. The present disclosure can fully calculate the information contained in the scattered wave data volume, and the imaging quality is high, not easily affected by seismic noise, and has good stability. Through the method in the present disclosure, compared with the migration imaging results obtained by the related technology, the migration imaging results finally obtained have better recognition and better quality.

Each module in the above-mentioned scattered wave migration imaging device can be implemented in whole or in part by software, hardware and a combination thereof. Each of the above-mentioned modules can be embedded in or independent of the processor in the device in the form of hardware, or can be stored in the memory in the processing device in the form of software, so that the processor can call and execute the operations corresponding to each of the above modules. It should be noted that the division of modules in the embodiment of the present disclosure is schematic, which is only a logical function division, and there may be other division methods in actual implementation.

The present disclosure also provides an electronic device, including a storage device and a processor, wherein the storage device stores a computer program, and the processor implements the above-mentioned method for migration imaging of the scattered wave when executing the computer program.

FIG. 6 is a block diagram of an electronic device according to an embodiment of the present disclosure. Referring to FIG. 6, the electronic device 600 includes a processor 601, a memory 602, and an interface 603. The processor 601 implements the operation of the migration imaging of the scattered wave by executing the computer executable instructions defining the method shown in FIG. 2. A computer program product including computer executable instructions may be stored in the memory 602. The method described in FIG. 2 may be defined by the computer executable instructions included in the computer program product and stored in the memory 602, and controlled by the processor 601 executing the computer executable instructions. The interface 603 may include a network interface for communicating with other devices via a network, and the interface may also include other input/output devices (e.g., a display, a keyboard, a mouse, a speaker, a button, a touch pad, a touch screen, etc.) that enable a user to interact with the electronic device 600. Those skilled in the art will recognize that the implementation of the actual control system may also include other components, and FIG. 6 is a high-level representation of some components of such a control system for illustrative purposes.

The memory 602 includes tangible, non-transitory machine-readable storage media and may also include high-speed random access memory, such as dynamic random access memory (DRAM), static random access memory (SRAM), double data rate synchronous dynamic random access memory (DDR RAM), or other random access solid-state memory devices, and may include non-volatile memory, such as one or more magnetic disk storage devices (such as internal hard disks and removable disks), magneto-optical disk storage devices, optical disk storage devices, flash memory devices, semiconductor memory devices (such as erasable programmable read-only memory (EPROM), electrically erasable programmable read-only memory (EEPROM)), compact disk read-only memory (CD-ROM), digital versatile disk read-only memory (DVD-ROM) disks, or other non-volatile solid-state storage devices.

The present disclosure also provides a storage medium, wherein a computer program stored in the storage medium can be executed by at least one processor, and the computer program can be used to implement the migration imaging method of the first aspect.

Those ordinary skilled in the art can understand that all or part of the processes in the above-mentioned embodiment methods can be completed by instructing the relevant hardware through a computer program, and the computer program can be stored in a non-volatile computer-readable storage medium. When the computer program is executed, it can include the processes of the embodiments of the above-mentioned methods. Any reference to memory, storage, database or other media used in the embodiments provided in the present disclosure may include at least one of non-volatile and volatile memory. Non-volatile memory may include read-only memory (ROM), tape, floppy disk, flash memory or optical memory, etc. Volatile memory may include random access memory (RAM) or external cache memory. As an illustration and not limitation, RAM can be in various forms, such as static random access memory (SRAM) or dynamic random access memory (DRAM).

The present disclosure also provides a computer program product, which includes a computer program and can be executed by at least one processor. The computer program can be used to implement the scattered wave migration imaging method as described above.

The present disclosure also provides a cloud computing system, which includes: one or more processors, which are connected to each other via a network; and a memory unit coupled to the one or more processors, wherein the memory unit stores a computer program in the form of machine-readable instructions executable by the one or more processors, wherein the machine-readable instructions cause the one or more processors to perform the scattered wave migration imaging method described above.

The present disclosure introduces the coherence principle in optical imaging, combines it with the migration imaging process, and proposes a coherent migration imaging operation or operator; and integrates the path integral method in mathematical theory into the scattered wave imaging process, and combines it with the coherent migration operator to propose a coherent path integral scattered wave imaging technology. The present disclosure no longer relies on an accurate velocity model, and overcomes the imaging blur caused by inaccurate velocity. The scattered wave imaging technology based on coherent path integral mainly provides technical reserves and technical support for oil and gas exploration and development. This technology innovatively develops the best imaging results under the scattered wave imaging framework, and has the characteristics of advanced methods, high imaging accuracy, distinctive features, and strong pertinence, which improves the imaging accuracy of karst fractures and caves in the northwest and southwest regions.

### Application Example 1

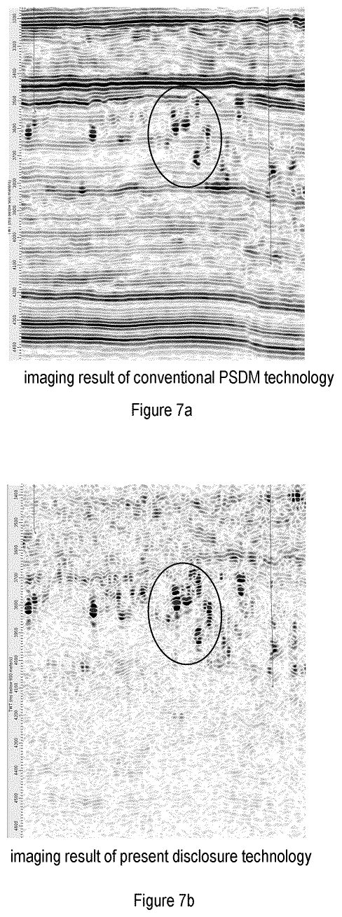

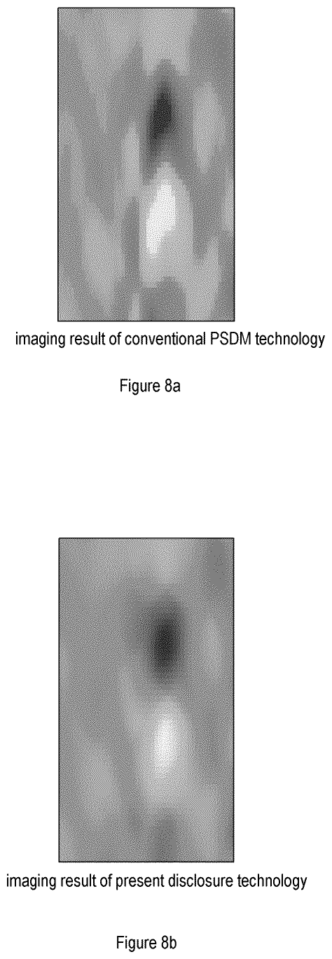

FIGS. 7a-8c are schematic diagrams comparing the imaging results of the conventional PSDM technology with the imaging results of the migration imaging method of the present disclosure, according to an application example of an embodiment of the present disclosure. In the specific embodiment 1 of the application of the present disclosure, the test data is the three-dimensional block data of the western part of Tahe region. FIG. 7a is the imaging result of the conventional PSDM technology, and FIG. 7b is the imaging result of the technology of the present disclosure based on coherent path integration. As shown in FIGS. 7a and 7b, from the comparison of the two results, it can be seen that the imaging results of the technology of the present disclosure are more prominent in small-scale cracks and holes, the structure is clearer, and the crack and hole recognition ability is significantly improved, compared with the imaging results of the conventional PSDM technology. As shown in FIGS. 8a, 8b and 8c, it can be clearly seen in the application example 1 of the western part of Tahe region that the focusing effect of the scattered wave imaging results of the technology of the present disclosure is significantly improved compared with the conventional scattered wave imaging in both plane and cross section, and the signal-to-noise ratio is significantly improved.

### Application Example 2

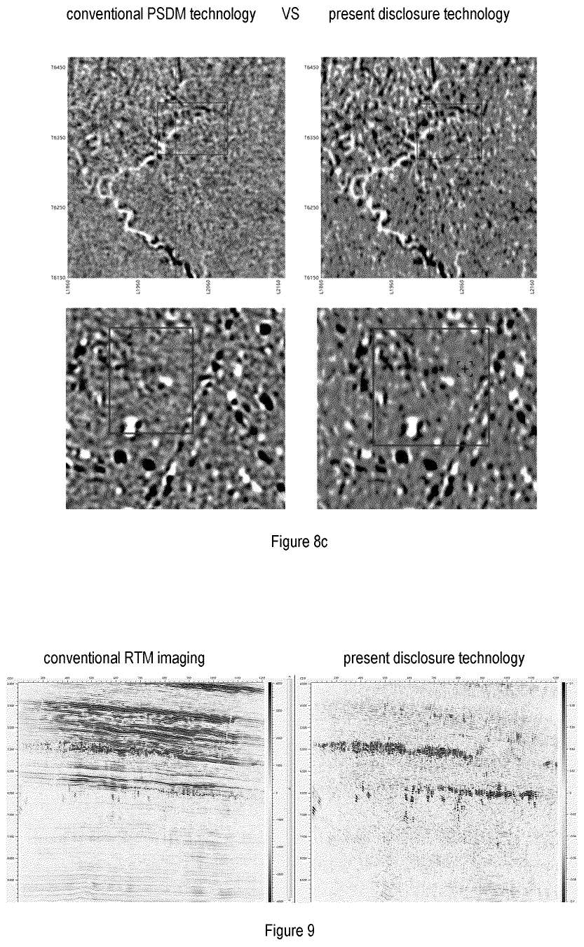

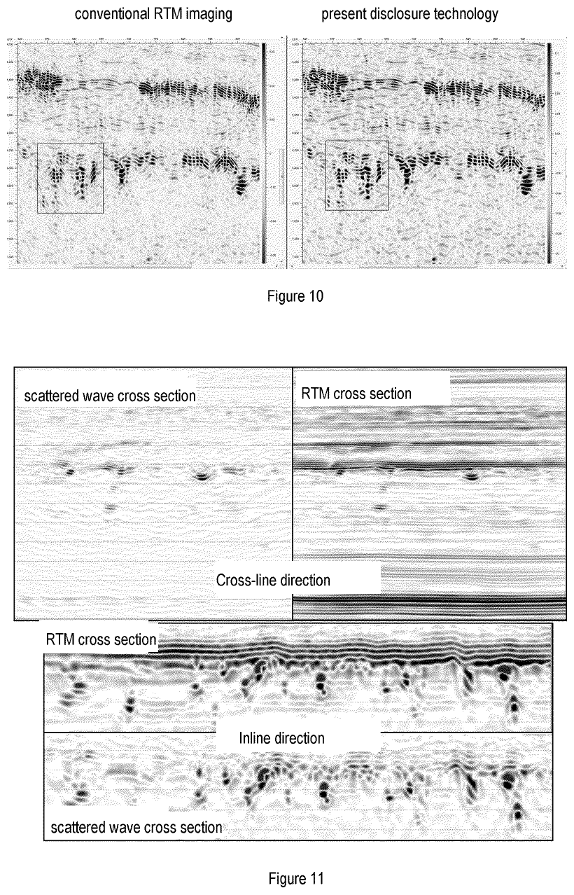

FIG. 9 and FIG. 10 are schematic diagrams comparing the imaging results of the conventional RTM technology with the imaging results of the migration imaging method of the present disclosure, according to another application example of the embodiment of the present disclosure. In the specific embodiment 2 of the application of the present disclosure, the test data is the AD6 high-density three-dimensional block data. According to the example of imaging of small-scale fracture and cave groups, FIG. 9 shows the imaging results of the conventional RTM technology (left side) and the imaging results of the disclosed technology based on coherent path integration (right side). As shown in FIG. 9, it can be seen from the AD6 high-density three-dimensional application effect that the imaging results of the scattered wave imaging technology of the present disclosure are more prominent than those of the conventional RTM technology for small-scale fracture and cave groups. According to an example of imaging of fractures and caves in small-scale carbonate reservoirs, FIG. 10 shows the imaging results of the conventional RTM technology (left side) and the imaging results of the disclosed technology based on coherent path integration (right side). As shown in FIG. 10, as compared with the conventional scattered wave imaging, it can be seen that the scattered wave imaging technology of the present disclosure is more focused in the imaging results of fractures and caves in small-scale carbonate reservoirs, and the energy is more prominent.

### Application Example 3

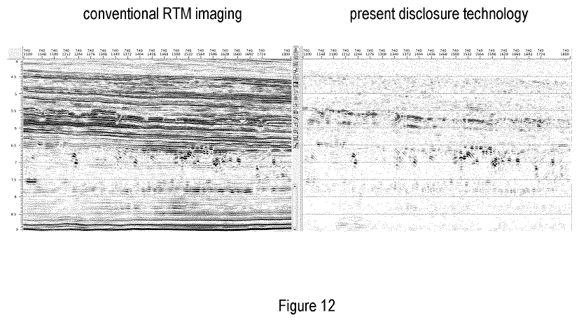

FIG. 11 and FIG. 12 are schematic diagrams comparing the imaging results of the conventional RTM technology with the imaging results of the migration imaging method of the present disclosure, according to still another application example of the embodiment of the present disclosure. In the specific embodiment 3 of the application of the present disclosure, the test data is the three-dimensional block data of the west of the tenth district of Tahe region. As shown in FIG. 11, the application example of the west of the tenth district of Tahe region shows that the scattered wave imaging can highlight the fracture and cave bodies with weak energy more than the RTM imaging. FIG. 12 respectively shows the imaging results of the conventional RTM technology (left side) and the imaging results of the technology of the present disclosure based on the coherent path integral (right side) in the case of small-scale carbonate reservoir fracture and cave imaging. As shown in FIG. 12, the application example of the west of the tenth district of Tahe region shows that, as compared with the conventional RTM imaging, it can be seen that the scattered wave imaging technology of the present disclosure can be effectively improved in the small-scale carbonate reservoir fracture and cave imaging.

It should be understood that “one embodiment” or “an embodiment” mentioned throughout the specification means that specific features, structures or characteristics related to the embodiment are included in at least one embodiment of the present disclosure. Therefore, “in one embodiment” or “in an embodiment” appearing throughout the specification does not necessarily refer to the same embodiment. In addition, these specific features, structures or characteristics can be combined in one or more embodiments in any suitable manner. It should be understood that in the various embodiments of the present disclosure, the size of the serial number of the above-mentioned processes does not mean the order of execution. The execution order of each process should be determined by its function and internal logic, and should not constitute any limitation on the implementation process of the embodiments of the present disclosure. The serial numbers of the embodiments of the present disclosure are for description only and do not represent the advantages and disadvantages of the embodiments.

It should be noted that, in this article, the terms “comprise”, “include” or any other variations thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “comprises a . . . ” does not exclude the existence of other identical elements in the process, method, article or device including the element.

In the embodiments provided in the present disclosure, it should be understood that the disclosed devices and methods can be implemented in other ways. The device embodiments described above are only schematic. For example, the division of units is only a logical function division. There may be other division methods in actual implementation, such as: multiple units or components can be combined, or can be integrated into another system, or some features can be ignored or not executed. In addition, the coupling, direct coupling, or communication connection between the components shown or discussed can be indirect coupling or communication connection through some interfaces, devices or units, which can be electrical, mechanical or other forms.

The units described above as separate components may or may not be physically separated, and the components displayed as units may or may not be physical units; they may be located in one place or distributed on multiple network units; some or all of the units may be selected according to actual needs to achieve the purpose of the present embodiment.

In addition, all functional units in the embodiments of the present disclosure may be integrated into one processing unit, or each unit may be separately configured as one unit, or two or more units may be integrated into one unit; the above-mentioned integrated units may be implemented in the form of hardware or in the form of hardware plus software functional units.

A person skilled in the art can understand that all or part of the steps of implementing the above method embodiment can be completed by hardware related to program instructions, and the aforementioned program can be stored in a computer-readable storage medium. When the program is executed, it executes the steps of the above method embodiment; and the aforementioned storage medium includes various media that can store program codes, such as mobile storage devices, read-only memories (ROM, Read Only Memory), disks or optical disks.

Alternatively, if the above-mentioned integrated unit of the present disclosure is implemented in the form of a software function module and sold or used as an independent product, it can also be stored in a computer-readable storage medium. Based on this understanding, the technical solution of the embodiment of the present disclosure can essentially or in other words, the part that contributes to the relevant technology can be embodied in the form of a software product, which is stored in a storage medium and includes a number of instructions for a controller to execute all or part of the methods described in each embodiment of the present disclosure. The aforementioned storage medium includes various media that can store program codes, such as mobile storage devices, ROMs, magnetic disks or optical disks.

The above is only an implementation of the present disclosure, but the protection scope of the present disclosure is not limited thereto. Any person skilled in the art who is familiar with the technical field can easily think of changes or substitutions within the technical scope in the present disclosure, which should be included in the protection scope of the present disclosure. Therefore, the protection scope of the present disclosure should be based on the protection scope of the claims.

1. A method for migration imaging of scattered wave, comprising:
acquiring a scattered wave data volume and one or more velocity models;
performing a coherent migration operation on the scattered wave data volume to generate a coherent migration operator corresponding to the scattered wave data volume;
generating one or more respective integration paths based on the one or more velocity models;
associating the coherent migration operator with the one or more respective integration paths, respectively, to determine one or more respective coherent migration results; and
superimposing the one or more respective coherent migration results to obtain a migration imaging result.

2. The method for migration imaging of scattered wave according to claim 1, further comprising at least one of the following:
before performing the coherent migration operation on the scattered wave data volume, filtering the scattered wave data volume; and
before performing the coherent migration operation on the scattered wave data volume, performing a thresholding process on the scattered wave data volume.

3. The method for migration imaging of scattered wave according to claim 1, wherein the performing the coherent migration operation on the scattered wave data volume comprises: performing the coherent migration operation on the scattered wave data volume according to partial information contained in the scattered wave data volume.

4. The method for migration imaging of scattered wave according to claim 3, wherein the performing the coherent migration operation on the scattered wave data volume comprises: for each data of at least a portion of data in the scattered wave data volume,
determining a scan length according to a sampling time of said each data, wherein the scan length is used to define a range of adjacent data required to perform the coherent migration operation; and
generating the coherent migration operator using adjacent data whose distances to each data are within the scan length.

5. The method for migration imaging of scattered wave according to claim 4, wherein, for data, U_{f}(x,y,t), in the scattered wave data volume, the coherent migration operator is generated according to the scanning length by the following formula:
$$ρ ( x , y , t ) = \frac{{[ {\sum }_{i = 0}^{R ( t )} \text{?} {U}_{f} ( x \pm i * dx , y \pm i * dy , t \pm i * dt ) ]}^{2} \text{?}}{{\sum }_{i = 0}^{R ( t )} {U}_{f}^{2} ( x \pm i * d x , y \pm i * dy , t \pm i * dt )}$$
wherein, U represents an amplitude of the scattered wave, f represents a frequency of the scattered wave, x represents an X-direction coordinate of the scattered wave and is between a first minimum value xₘᵢₙ first maximum value xₘₐₓ presents a Y-direction coordinate of the scattered wave and is between a second minimum value yₘᵢₙ second maximum value yₘₐₓ represents a X-direction step of the scattered wave, dy represents a Y-direction step of the scattered wave, t represents a sampling time of the scattered wave and is between zero and a maximum sampling time t_max, dt represents a sampling time step in a longitudinal direction T; ρ represents the coherent migration operator; R(t) represents the scanning length and is a function of the sampling time t, i=0, . . . , R(t), and R(t) is a positive integer;
$${\sum }_{i = 0}^{R ( t )}$$
. . . represents a sum or each term from i=0 to R(t); and
x, y and t are changed respectively, and the above steps for coherent migration operator generation are repeated until coherent migration operators of part or all of data in the scattered wave data volume are determined.

6. The method for migration imaging of scattered wave according to claim 5, wherein the scanning length R(t) is proportional to the sampling time t, or the scanning length R(t) is a constant.

7. The method for migration imaging of scattered wave according to claim 1, wherein acquiring the one or more velocity models comprises: receiving the one or more velocity models from outside, predefining the one or more velocity models, or randomly generating the one or more velocity models.

8. The method for migration imaging of scattered wave according to claim 5, wherein the number n of the one or more velocity models is determined by the following formula:
n=(v_{b}−vₐ)/dv+1, where, v_{b} represents an upper speed limit of the speed model, vₐ represents a lower speed limit of the speed model, and dv represents a speed step, wherein a jth speed model is represented by vⱼ, j=1, . . . , n, where vⱼ value is equal to (j−1)*dv+vₐ.

9. The method for migration imaging of scattered wave according to claim 8, wherein the generating one or more respective integral paths based on the one or more velocity models comprises:
for the jth velocity model in the one or more velocity models, a jth integral path is generated by the following formula:
$${τ}_{j} ( x , y , t ) = \sqrt{{t}^{2} + ( \frac{{( 2 {r}_{j} )}^{2}}{{v}_{j}^{2} ( x , y , t )} )}$$
wherein, τⱼ represents the jth integral path, j=1, . . . , n; rj represents an migration aperture, wherein the migration aperture represents a preset value required to process the jth velocity model; vⱼ represents the jth velocity model, wherein vⱼ value is equal to (j−1)*dv+vₐ; and
by changing j, the above steps for integration path generation are repeated until all velocity models are converted into respective integration paths.

10. The method for migration imaging of scattered wave according to claim 9, wherein the associating the coherent migration operator with the one or more respective integral paths to determine the respective coherent migration results comprises:
associating the coherent migration operator with the jth integration path by the following formula to determine a jth coherent migration result:
$${S}_{j} ( x , y , t ) = {\int }_{0}^{{t}_{max}} \{ \frac{{δ ( t - {τ}_{j} ( x , y , t ) ) [ {\sum }_{i = 0}^{R ( t )} \text{?} {U}_{f} ( x \pm i * dx , y \pm i * dy , t \pm i * d t ) ]}^{2} \text{?}}{{\sum }_{i = 0}^{R ( t )} {U}_{f}^{2} ( x \pm i * dx , y \pm i * dy , t \pm i * d t )} \} dt$$
where, Sⱼ represents the jth coherent migration result; ∫ represents an integral sign, representing a summation of terms in curly brackets at different times; tₘₐₓ sents the maximum sampling time; δ represents a Dirac function; dt represents the sampling time step; and
by changing j, the above association step is repeated until all the integration paths are associated with the coherent migration operator to determine the respective coherent migration results.

11. The method for migration imaging of scattered waves according to claim 10, wherein the superimposing the respective coherent migration results to obtain the migration imaging result is performed by the following formula:
$$D ( x , y , t ) = {\sum }_{j = 1}^{n} {S}_{j} ( x , y , t )$$
wherein, D(x,y,t) represents the migration imaging result, indicating a probability of existence of a scatterer at position coordinate (x,y) at the sampling time t; Σ represents a summation sign.

12. A device for migration imaging of scattered wave, comprising:
an acquisition module configured to acquire a scattered wave data volume and one or more velocity models;
an execution module, configured to perform a coherent migration operation on the scattered wave data volume to generate a coherent migration operator corresponding to the scattered wave data volume;
a generation module configured to generate one or more respective integral paths based on the one or more velocity models;
an association module configured to associate the coherent migration operator with the one or more integration paths respectively to determine respective coherent migration results; and
a superposition module configured to superimpose the respective coherent migration results to obtain a migration imaging result.

13. (canceled)

14. A storage medium storing a computer program capable of being executed by at least one processor, wherein the computer program can be used to implement the method for migration imaging of scattered waves according to claim 1.

15.-16. (canceled)
